(19) United States
(12) Patent Application Publication
(10) Pub. No.: US 2019/0226756 A1
(43) Pub. Date: Jul. 25, 2019

(54) REFRIGERATION CONTROL UNIT

(71) Applicant: Johnson Controls Technology Company, Auburn Hills, MI (US)

(72) Inventors: Dave P. DeBoer, Cedarburg, WI (US); Tai P. Luc, South Milwaukee, WI (US); Timothy J. Riesch, Germantown, WI (US); Kirk P. Henderson, Oconomowoc, WI (US); Tim Butler, Milwaukee, WI (US); Krishna Danturti, Milwaukee, WI (US)

(73) Assignee: Johnson Controls Technology Company, Auburn Hills, MI (US)

(21) Appl. No.: 16/252,536

(22) Filed: Jan. 18, 2019

Related U.S. Application Data
(60) Provisional application No. 62/619,605, filed on Jan. 19, 2018.
(60) Provisional application No. 62/665,964, filed on May 2, 2018.

(51) Int. Cl. F25D 29/00; F24F 11/30; G05B 15/02

(52) U.S. Cl. CPC F25D 29/005; F24F 11/30; F25D 2700/123; F25D 2400/361; F25D 2400/40; G05B 15/02

(57) ABSTRACT

A refrigeration control unit configured to modify an operating condition of a refrigeration unit is provided. The refrigeration control unit includes a first device housing component and a second device housing component defining a main refrigeration control device. The refrigeration control unit further includes a user interface component. The user interface component includes multiple controls configured to permit selection of multiple refrigeration unit operating parameters and a display. The user interface component is configured to be detachably coupled to the main refrigeration control device such that the user interface component is operational both when mounted in the main refrigeration control device and when mounted at a location remote to the main refrigeration control device.

### CROSS-REFERENCE TO RELATED APPLICATIONS

This application claims the benefit of and priority to U.S. Provisional Patent Application No. 62/619,605 filed Jan. 19, 2018, and U.S. Provisional Patent Application No. 62/665,964 filed May 2, 2018. Both are incorporated by reference herein in their entireties.

### BACKGROUND

Refrigeration control units may be used to control commercial refrigeration equipment, including walk-in refrigerators, coolers, and freezers installed in grocery stores, restaurants, and the like. In some cases, refrigeration control units may also be used to control refrigeration and freezer cases for the display and distribution of food service products. A refrigeration control unit with improved mounting and user interface features would be useful.

### SUMMARY

One implementation of the present disclosure is a refrigeration control unit configured to modify an operating condition of a refrigeration unit. The refrigeration control unit includes a first device housing component and a second device housing component defining a main refrigeration control device. The refrigeration control unit further includes a user interface component. The user interface component includes controls configured to permit selection of multiple refrigeration unit operating parameters and a display. The user interface component is configured to be detachably coupled to the main refrigeration control device such that the user interface component is operational both when mounted in the main refrigeration control device and when mounted at a location remote to the main refrigeration control device.

In some embodiments, the user interface component is electrically coupled to the main refrigeration control device using an accessory cable. In other embodiments, the accessory cable has a length ranging from 8 feet to 12 feet.

In some embodiments, the user interface component has an IP54 ingress protection rating.

In some embodiments, the controls include capacitive sensor-based buttons.

In some embodiments, the main refrigeration control device further includes a low voltage component circuit board and a high voltage component circuit board.

In some embodiments, the second device housing component includes features configured to permit the refrigeration control unit to mount to a DIN rail.

In some embodiments, the first device housing component and the second device housing component are coupled using a snap fit assembly process.

In some embodiments, the refrigeration unit is a walk-in refrigerator, a cooler, or a freezer case.

Another implementation of the present disclosure is refrigeration control unit configured to modify an operating condition of a refrigeration unit. The refrigeration control unit includes a first device housing component, a second device housing component, and multiple controls configured to permit selection of multiple parameter values for multiple refrigeration unit operating parameters. The refrigeration control unit further includes a processing circuit communicably coupled to the controls and multiple sensors. The processing circuit is configured to receive sensor measurements from the sensors, receive a command from the controls to assign a sensor weight to each of the sensor measurements, calculate a weighted average from the sensor measurements, and transmit a command to modify an operating condition of the refrigeration unit based on the weighted average.

In some embodiments, the sensors include temperature sensors.

In some embodiments, the controls include capacitive sensor-based buttons.

In some embodiments, the refrigeration unit operating parameters include at least one of a temperature unit, a backlight intensity, a system name, a time format, a date format, and an alarm setting.

In some embodiments, the refrigeration unit operating parameters include defrost parameters including at least one of a defrost type, a defrost termination type, a defrost duration, a number of defrosts performed per 24 hour period, and a defrost schedule.

In some embodiments, the refrigeration unit operating parameters include sensor parameters including at least one of a sensor type, a sensor offset, a sensor measurement function, and a sensor weight.

In some embodiments, the processing circuit is further configured to receive a command from the controls to create a configuration file. The configuration file includes refrigeration unit operating parameters and parameter values. The processing circuit is further configured to export the configuration file to a removable storage device. The removable storage device is communicably coupled to a universal serial bus (USB) port of the refrigeration control unit.

In some embodiments, the refrigeration unit is a walk-in refrigerator, a cooler, or a freezer case.

Yet another implementation of the present disclosure is a method of operating a refrigeration unit using a refrigeration control unit. The method includes receiving sensor measurements from multiple sensors, receiving a command from controls to assign a sensor weight to each of the sensor measurements, calculating a weighted average from the sensor measurements, and transmitting a command to modify an operating condition of the refrigeration unit based on the weighted average.

In some embodiments, the sensors measurements include temperature measurements.

In some embodiments, the method further includes receiving a command from the controls to create a configuration file. The configuration file includes refrigeration unit operating parameters and parameter values. The method further includes exporting the configuration file to a removable storage device. The removable storage device is communicably coupled to a universal serial bus (USB) port of the refrigeration control unit.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

FIG. 1 is a perspective view of a refrigeration control unit, according to some embodiments.

FIG. 2 is another perspective view of the refrigeration control unit of FIG. 1, according to some embodiments.

FIG. 3 is a front elevation view of the refrigeration control unit of FIG. 1, according to some embodiments.

FIG. 4 is a side elevation view of the refrigeration control unit of FIG. 1, according to some embodiments.

FIG. 5 is another side elevation view of the refrigeration control unit of FIG. 1, according to some embodiments.

FIG. 6 is a rear elevation view of the refrigeration control unit of FIG. 1, according to some embodiments.

FIG. 7 is an exploded view of the refrigeration control unit of FIG. 1, according to some embodiments.

FIG. 8A is a perspective view of the remote mounting feature of the refrigeration control unit of FIG. 1, according to some embodiments.

FIG. 8B is an exploded perspective view of the user interface component, according to some embodiments.

FIG. 9 is a perspective view of another refrigeration control unit, according to some embodiments.

FIG. 10 is another perspective view of the refrigeration control unit of FIG. 9, according to some embodiments.

FIG. 11 is a front elevation view of the refrigeration control unit of FIG. 9, according to some embodiments.

FIG. 12 is a rear elevation view of the refrigeration control unit of FIG. 9, according to some embodiments.

FIG. 13 is a side elevation view of the refrigeration control unit of FIG. 9, according to some embodiments.

FIG. 14 is another side elevation view of the refrigeration control unit of FIG. 9, according to some embodiments.

FIG. 15 is a perspective view of the internal components of the refrigeration control unit of FIG. 9, according to some embodiments.

FIG. 16 is a perspective view of electronics enclosure mounting features of the refrigeration control unit of FIG. 9, according to some embodiments.

FIG. 17 is an exploded view of the refrigeration control unit of FIG. 9, according to some embodiments.

FIG. 18 is another perspective view of electronics enclosure mounting features of the refrigeration control unit of FIG. 9, according to some embodiments.

FIG. 19 is a sectional view of the refrigeration control unit of FIG. 9, according to some embodiments.

FIG. 20 is a front elevation view of the refrigeration control unit of FIG. 1, according to some embodiments.

FIG. 21 is a front elevation view of the refrigeration control unit of FIG. 9, according to some embodiments.

FIG. 22 is a block diagram of a refrigeration control unit, according to some embodiments.

### DETAILED DESCRIPTION

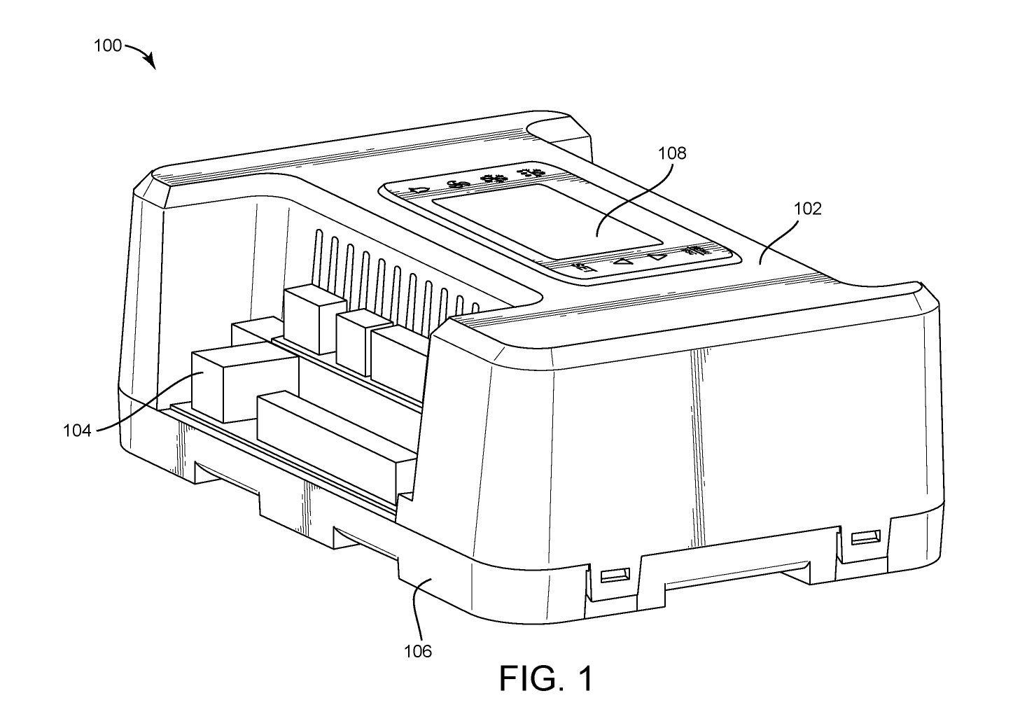

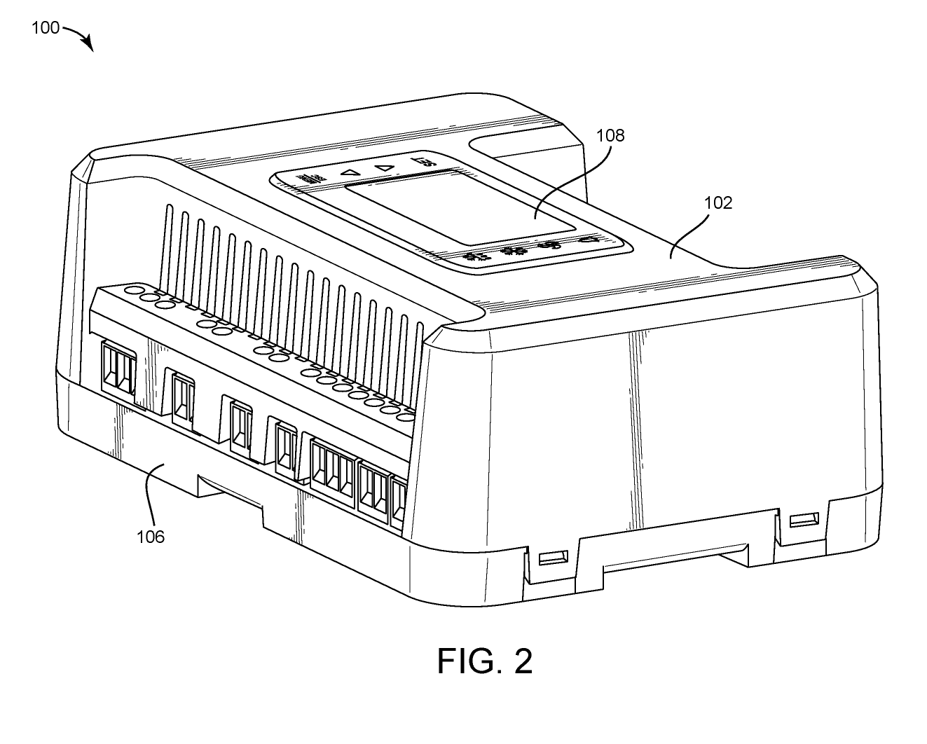

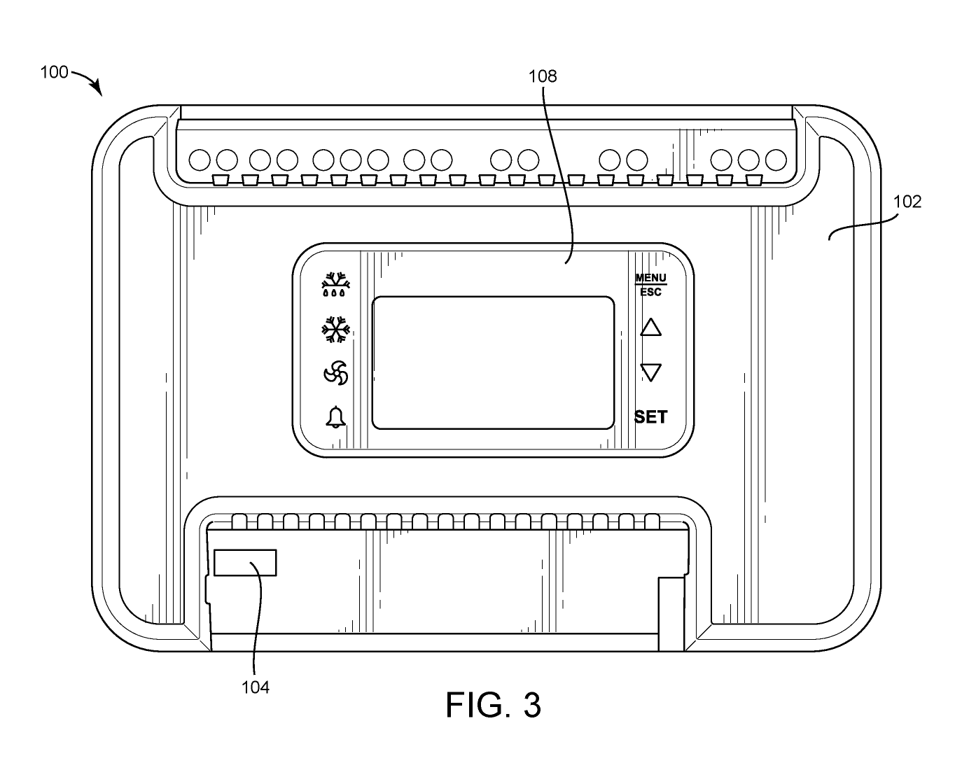

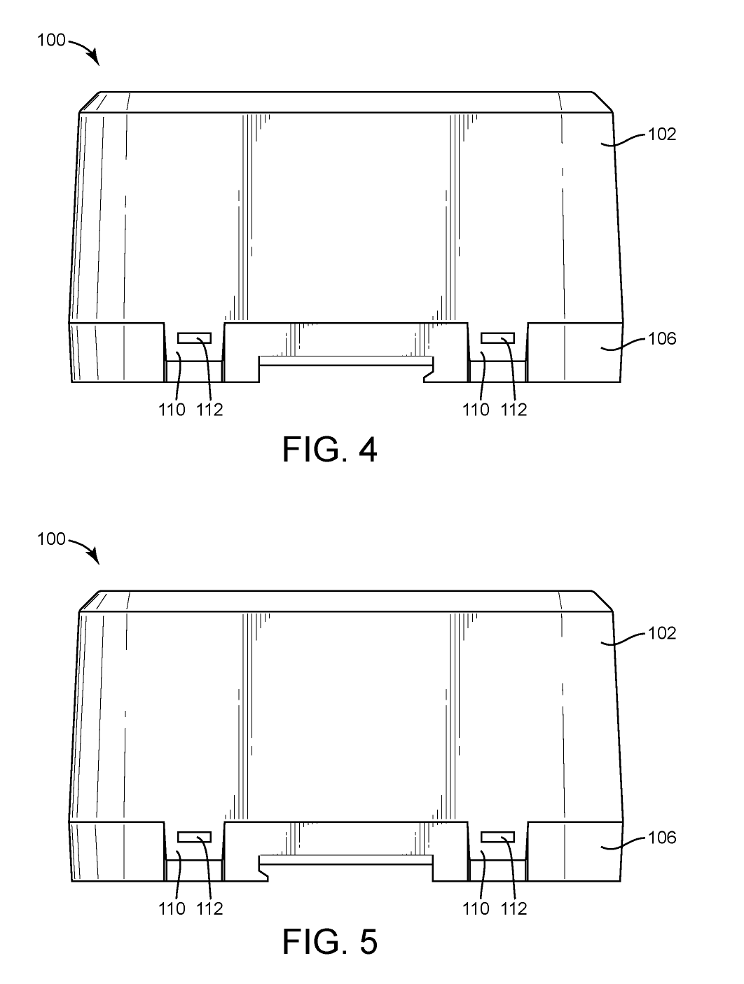

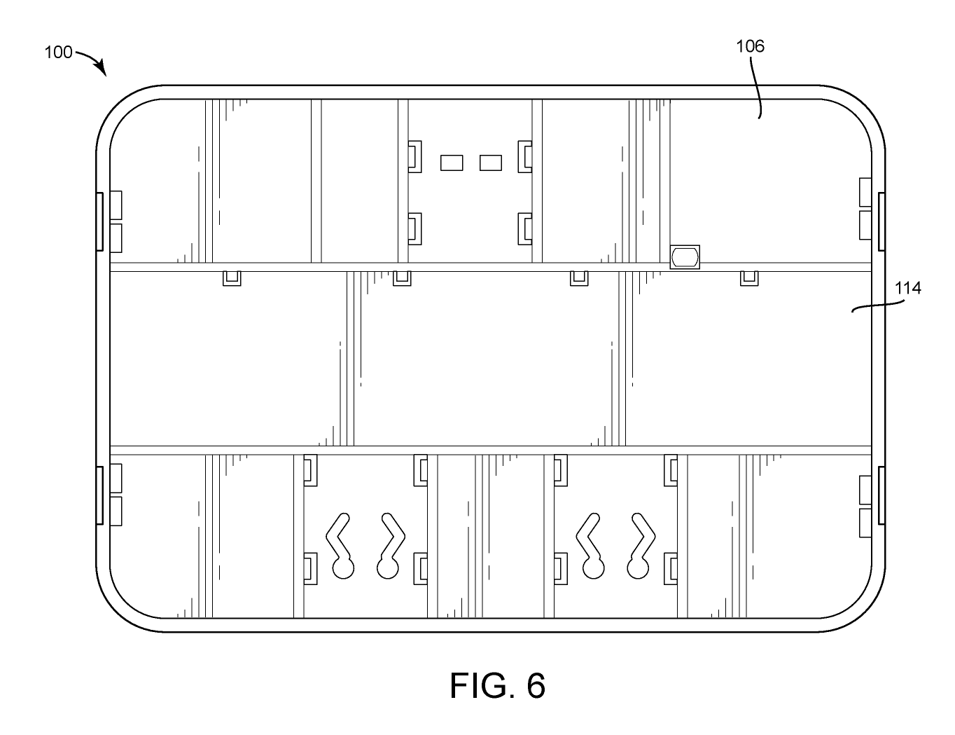

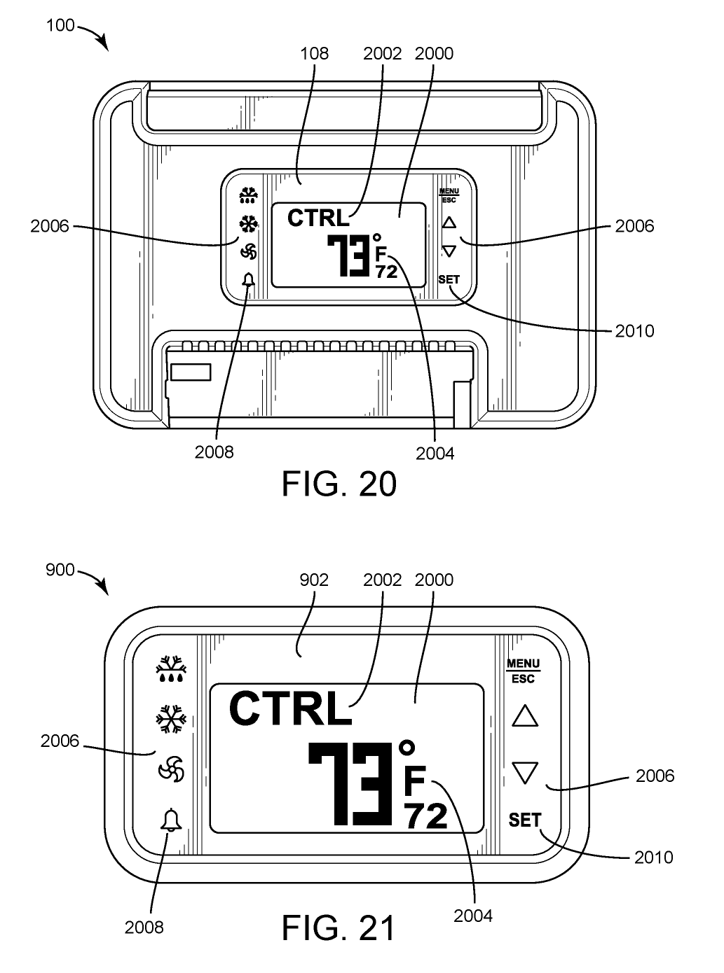

Referring generally to FIGURES, disclosed herein are various embodiments related to a refrigeration control unit. FIGS. 1-6 depict various views of the exterior of a refrigeration control unit 100. Specifically, FIGS. 1 and 2 depict perspective views, FIG. 3 depicts a front elevation view, FIGS. 4 and 5 depict side elevation views and FIG. 6 depicts a rear elevation view. Refrigeration control unit 100 may be configured to control commercial refrigeration equipment, including walk-in refrigerators, coolers, and freezers installed in grocery stores, restaurants, and the like. In some embodiments, refrigeration control unit devices may also be used to control refrigeration and freezer cases for the display and distribution of food service products. As shown, refrigeration control unit 100 may include, among other components, a first enclosure component 102, a universal serial bus (USB) port 104, a second enclosure component 106, and a user interface component 108. The user interface component 108 includes a display and unit controls which are described in further detail below with reference to FIGS. 20 and 21.

Referring specifically to FIG. 3, a front elevation view of the refrigeration control unit 100 is depicted. The refrigeration control unit 100 is shown to include a USB port 104 that may enable a cloning feature of user-configurable parameters of the refrigeration control unit 100. For example, in some embodiments, a user or technician configuring the parameters of one refrigeration control unit may wish to utilize the same parameters across all refrigeration control units utilized in a facility. The cloning process may begin with the user selecting and/or configuring all desired parameters on the first refrigeration control unit 100. Example refrigeration unit parameters and their possible values are included below in Table 1. As shown, possible parameters configurable by a user may include, but are not limited to, unit display parameters, user interface parameters, BACnet parameters, sensor parameters, and defrost process parameters. After the user has selected and/or configured all desired parameters, the user may insert a flash drive or other type of removable storage into the USB port 104 and may export a configuration file containing all desired parameters and parameter values to the flash drive or removable storage. The cloning process concludes as the user inserts the flash drive or removable storage into the USB ports 104 of all additional refrigeration control units 100 and imports the configuration file into the processing circuits of the additional refrigeration control units utilized in the facility.

TABLE 1
Example Refrigeration Control Unit Parameters and Parameter Values

| Parameter | Parameter Values |
|---|---|
| Units | Fahrenheit/Celsius |
| Backlight Intensity | Display brightness level |
| System Name | User assigned |
| Time Format | 12/24 hour display |
| Date Format | Month-Day-Year, Day-Month-Year |
| Auto Daylight Savings Time | Automatically adjust for DST (enable/disable) |
| BACnet Address | Network address |
| BACnet ID | Network Object ID |
| BACnet Baud | Communication baud rate |
| Precision Superheat Control | Installed - Yes/No |
| Sensor Type | Sensor type, A99 or NTC |
| Sensor Offset | User adjustment, calibrate due to sensor length |
| Sensor Measure | Function - space temp or defrost termination |
| Sensor Weight | Sensor weighting |
| Anti-short Cycle Delay | Prevents excessive cycling of equipment |
| Setpoint | Target space temperature |
| Differential | Used with setpoint, establishes refrigeration On/Off points |
| Sensor Failure Mode | Upon sensor failure - refrigeration On, Off, or Cycle |
| Defrost Type | Passive, Electric Heat, Hot Gas |
| Defrost Termination Type | Time, Sensor |
| Defrost Duration | Defrost interval, minutes |
| Drip Time | Drip interval, allow water to drip off evaporator, minutes |
| Defrosts per Day | Number of defrosts performed per 24 hour period |
| Defrost Evenly | Evenly spaced defrosts (in time) - Yes/No |
| Defrost Schedule | List of defrost start times |
| Defrost Algorithm | Scheduled or Adaptive |
| Adaptive Defrost Interval | Time between defrosts |
| Adaptive - Max Defrost Interval | Maximum amount of time between defrosts |
| Adaptive - Min Defrost Interval | Minimum amount of time between defrosts |
| Adaptive - Start of Blackout | Time of day when the blackout period begins (no defrosts allowed) |
| Adaptive - Blackout Duration | Length of blackout period |
| Binary Input | Mode, Active State, Action, and Action Delay |
| Alarm Setting | Enabled, Threshold, Delay, Re-alarm interval |

In some embodiments, as shown in FIG. 3, the USB port 104 is accessible from the exterior of the refrigeration control unit 100. In other embodiments, the USB port 104 is at least partially encapsulated within the first enclosure component 102 and is accessible behind a door or dust cover. In yet further embodiments, rather than or in addition to utilizing a flash drive for cloning, other methods of transferring a configuration file may be utilized, including, but not limited to, wireless communications (e.g., via Bluetooth, Wi-Fi, local area network (LAN), etc.), via cloud storage, web transfer, a transfer cable (e.g., using a SATA, eSATA, or other interface), etc.

Referring now to FIGS. 4 and 5, side elevation views of the refrigeration control unit 100 are depicted. As shown, in one embodiment, the first enclosure component 102 and the second enclosure component 106 may be coupled using a snap fit process in which latching components 110 of the first enclosure component 102 fit over protrusion features 112 of the second enclosure component 106. In other embodiments, the enclosure components 102 and 106 may be coupled using any suitable mechanism (e.g., fasteners, hinges). Referring now to FIG. 6, a rear elevation view of the refrigeration control unit 100 is depicted. As shown, second enclosure component 106 may include a DIN rail feature 114 that permits the refrigeration control unit 100 to be mounted on a DIN rail (e.g., a type of standardized metal rail widely used to mount circuit breakers and other industrial control equipment inside equipment racks). In various embodiments, the DIN rail can be a top hat rail (also known as a type O, type Omega, or T35 rail), a C section rail, or a G section rail. For example, the DIN rail feature 114 can include features including, but not limited to, clips, recesses, and protrusions. In other embodiments, second enclosure component 106 may include any features (e.g., holes, slots) required to mount the refrigeration control unit 100 in its installation location.

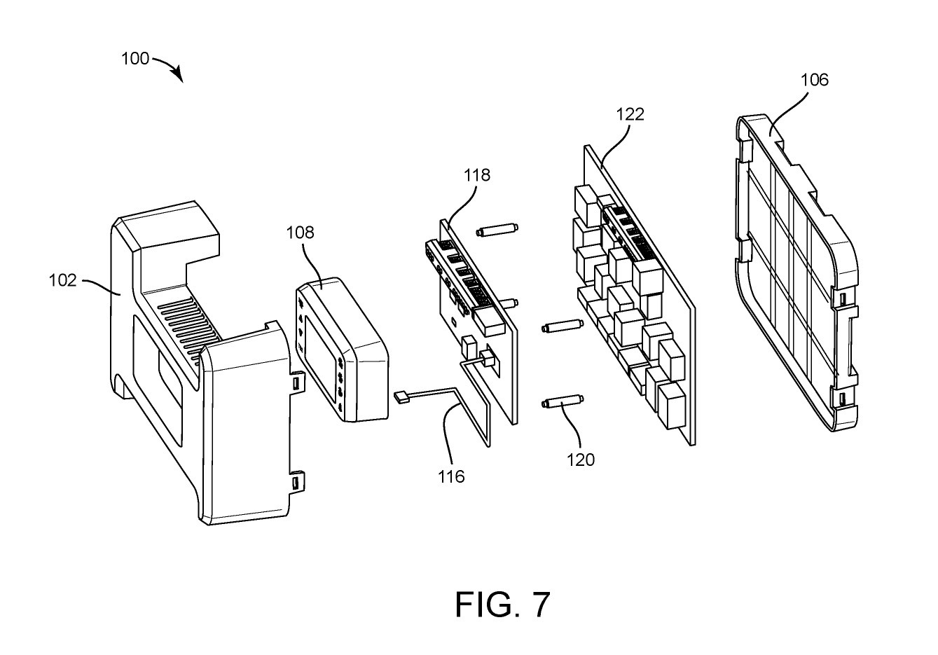

Turning now to FIG. 7, an exploded view of the refrigeration control unit 100 is depicted. As shown, control unit 100 includes a first enclosure component 102, a user interface component 108, a low voltage component board 118 that is coupled to user interface component 108 via wire routing 116, and a high voltage component board 122 that is coupled to the low voltage component board 108 via multiple standoffs 120. Control unit 100 is further shown to include a second enclosure component 106 that may be detachably coupled to the first enclosure component 102.

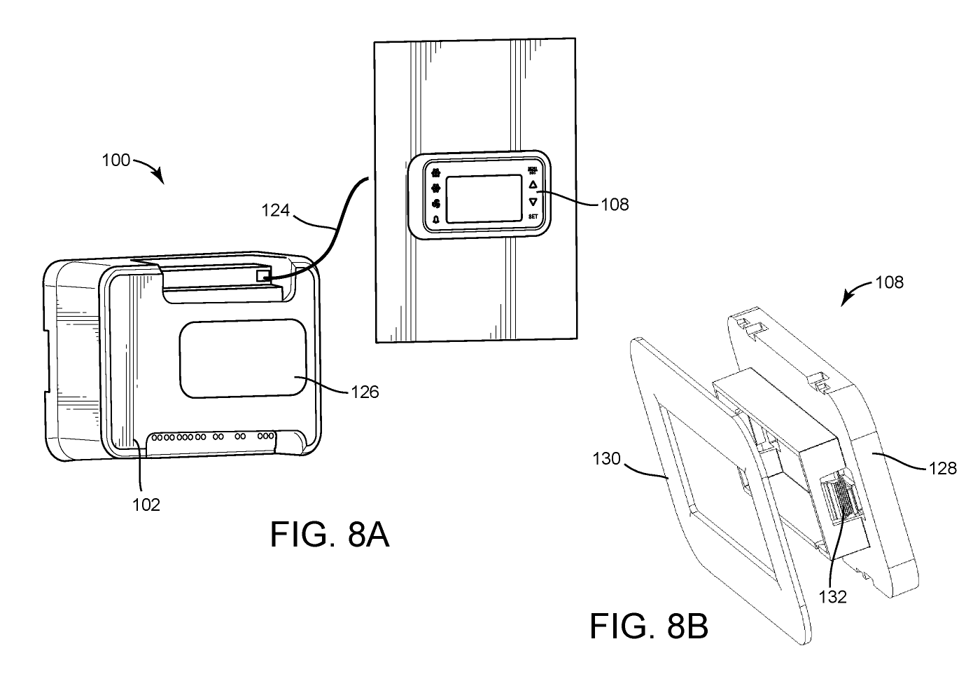

FIG. 8A depicts the remote mounting capabilities of the refrigeration control unit 100. As shown, the user interface component 108 may be removed from the refrigeration control unit 100 and mounted in a different location from the remainder of the refrigeration control unit 100. For example, in some embodiments, the installation location for the control unit 100 may require both user accessibility and the ability to wash the installation location with water and/or cleaning fluid (e.g., a freezer compartment used to store food). Since the user interface component 108 may be better protected against water ingress than the rest of the refrigeration control unit 100 (e.g., the user interface component 108 may have an IP54 ingress protection rating), the user interface component 108 may be mounted separately and connected to the refrigeration control unit 100 using an accessory cable 124. In some embodiments, the length of the accessory cable 124 permits the user interface component 108 to be mounted up to 10 feet or more away from the refrigeration control unit 100. For example, in some embodiments, the accessory cable can have a length ranging from 8 feet to 12 feet. In some embodiments, when the user interface component 108 is mounted remotely, the opening for the user interface component 108 in the first enclosure component 102 may be covered by a cover plate accessory 126. Referring to FIG. 8B, an exploded view of the user interface component 108 is depicted. When mounted remotely from the first enclosure component 102, the user interface component 108 may include a remote mounting case 128 with a gasket seal 130. Gasket seal 130 may permit the user interface component 108 to achieve an IP54 water ingress rating when the user interface component 108 is mounted in a panel opening. The remote mounting case 128 may include one or more self-latching design features 132 that grip the panel opening to maintain pressure on the gasket seal 130.

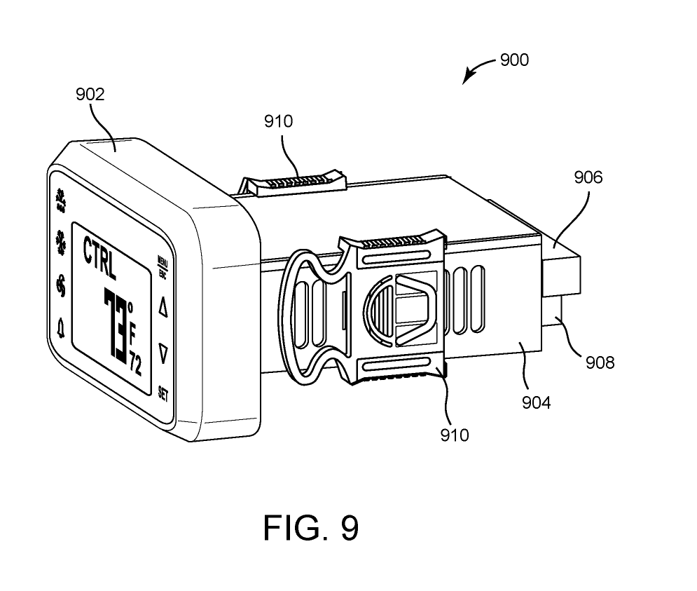

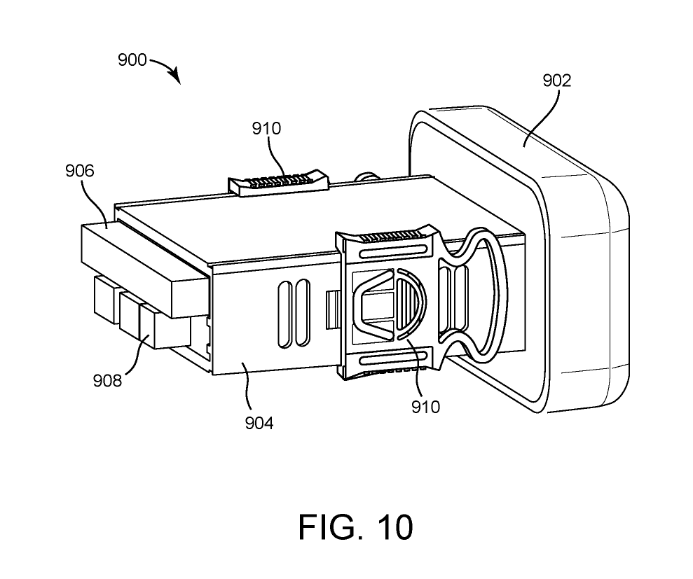

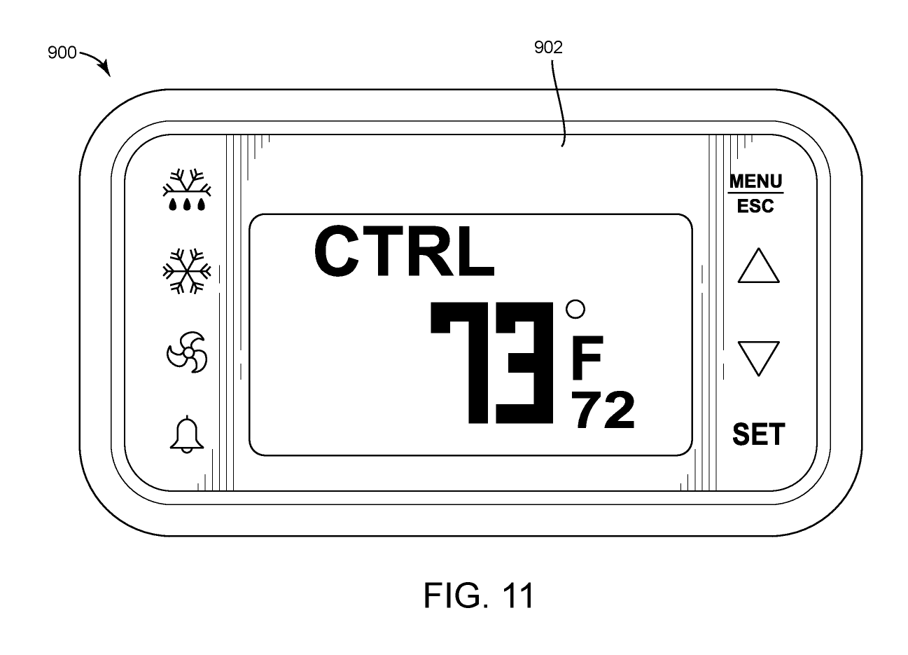

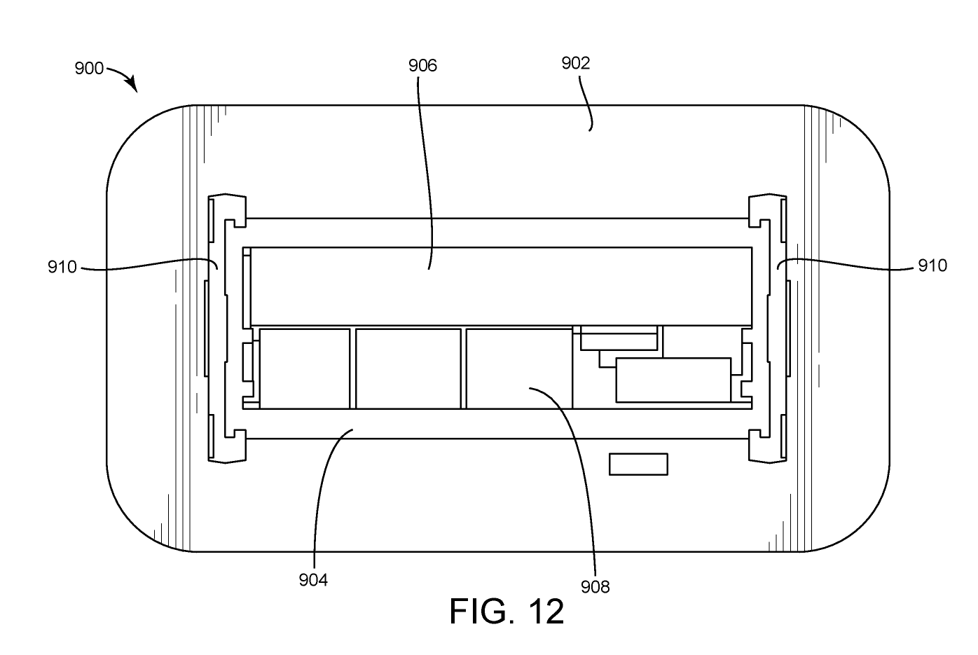

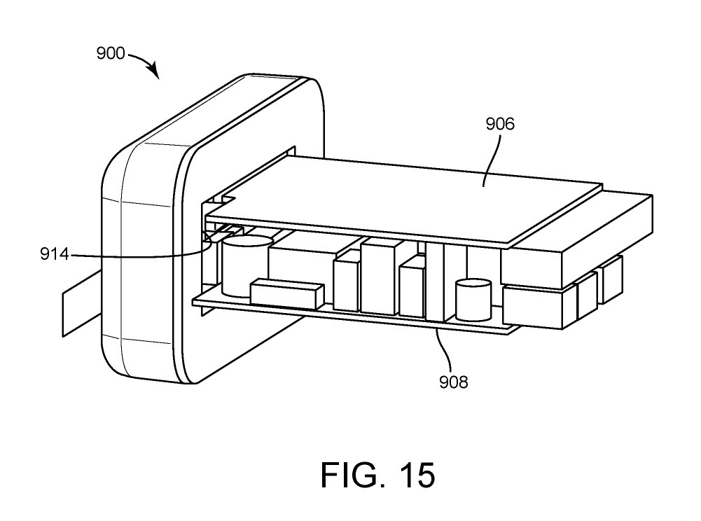

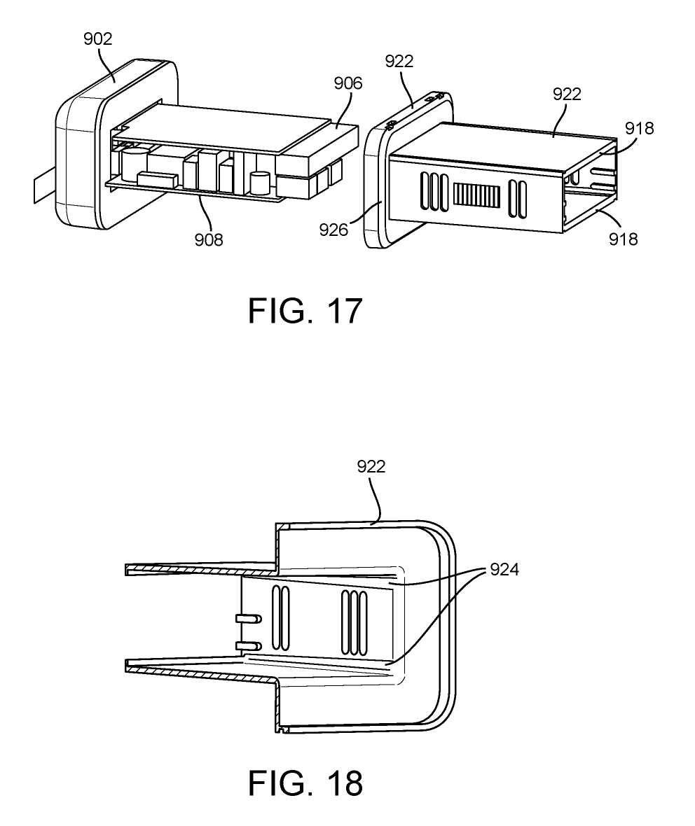

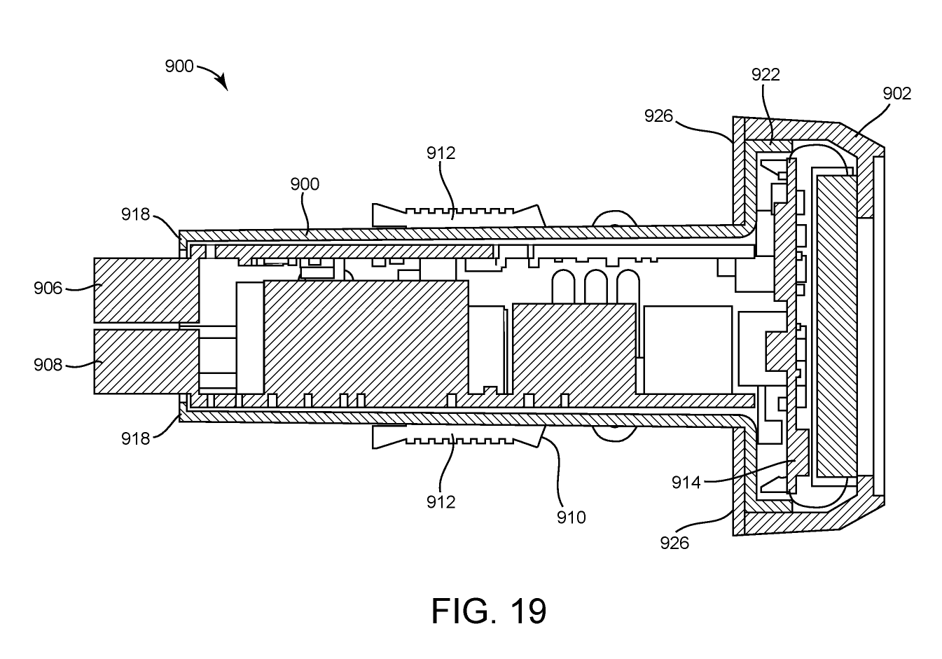

Referring now to FIGS. 9-19, another example implementation of a refrigeration control unit 900 is depicted. Specifically, FIGS. 9 and 10 depict perspective views, FIG. 11 depicts a front elevation view, FIG. 12 depicts a rear elevation view, and FIGS. 14 and 15 depict side elevation views. Similar to refrigeration control units 100, refrigeration control unit 900 is shown to include a user interface component 902. In some embodiments, user interface component 902 is identical or substantially similar to user interface component 108, described above with reference to FIGS. 1-9. User interface component 902 may include both a display and unit controls, described in further detail below with reference to FIGS. 20 and 21. Although smaller in form factor than refrigeration control unit 100, refrigeration control unit 900 may be configured to perform many of the same functions as refrigeration control unit 100. For example, approximately 80-90% of the firmware for refrigeration control unit 900 may be identical to the firmware of refrigeration control unit 100.

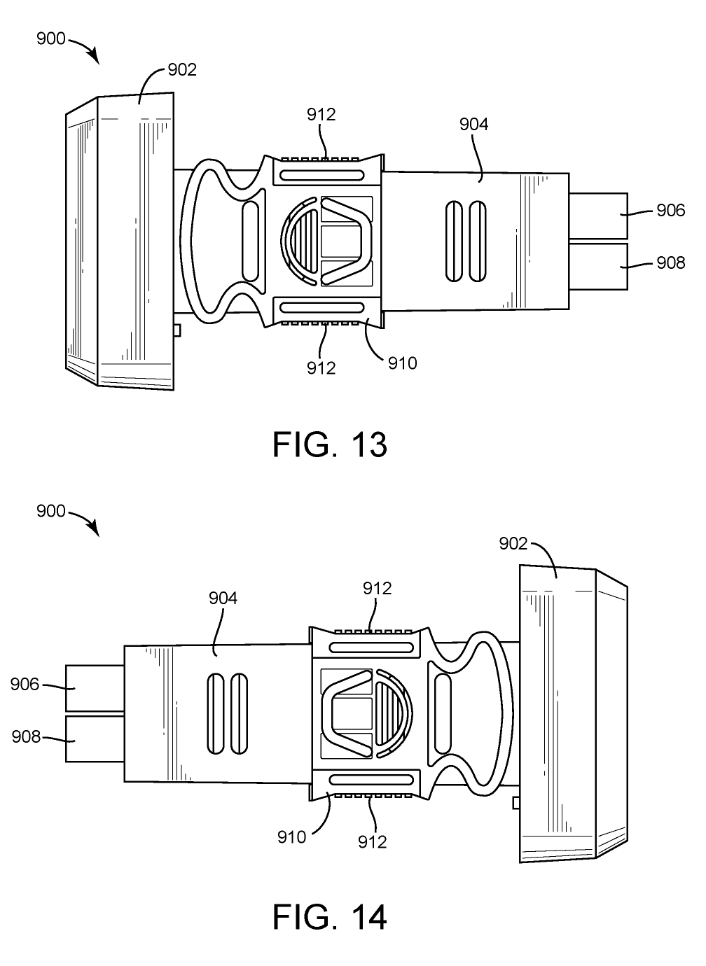

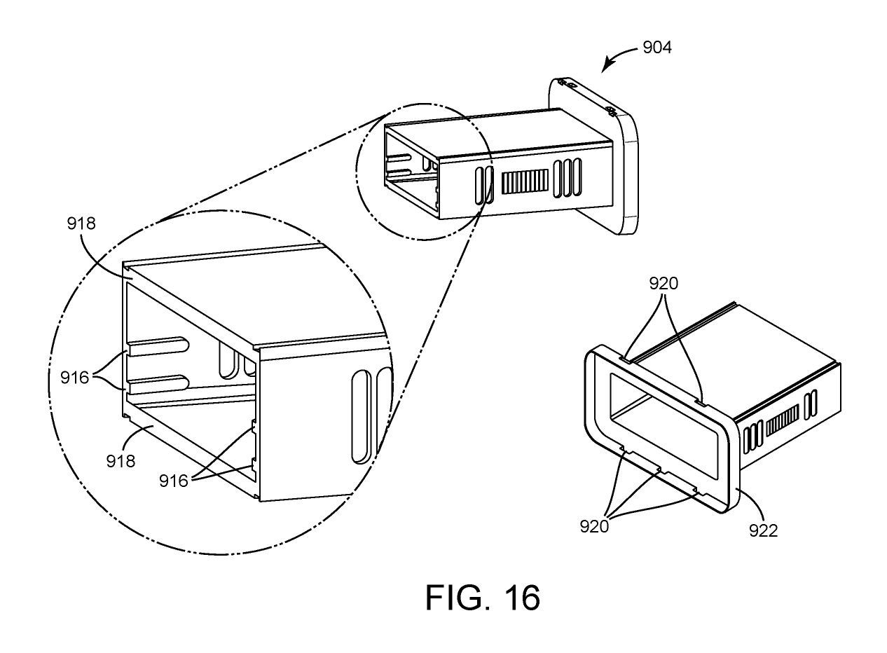

As shown, user interface component 902 may be coupled to an electronics enclosure 904. Electronics enclosure 904 may be configured to house a first printed circuit board (PCB) 906 and a second PCB 908. Due to the small size of the refrigeration control unit 900, certain PCB locating features are integrated into the electronics enclosure 904 to locate the PCBs 906 and 908 relative to each other and the electronics enclosure 904. These locating features are described in further detail below with reference to FIGS. 16-19. Refrigeration control unit 900 is further shown to include mounting brackets 910 on either side of the electronics enclosure 904. Mounting brackets 910 may be configured to couple the refrigeration control unit 900 to mounting rails and may permit easy push and pull installation motions. As shown in FIGS. 13 and 14, mounting brackets 910 may also include ergonomic grip features 912 that provide a user with a secure hold as the user installs the refrigeration control unit 900.

Turning now to FIG. 15, a perspective view of the internal components of the refrigeration control unit 900 are depicted. In addition to the first PCB 906 and the second PCB 908 housed inside electronics enclosure 904, refrigeration control unit 900 is shown to include a user interface PCB 914 (the “UI PCB”) housed within the user interface component 902. First PCB 906 and second PCB 908 may be configured to electrically couple to the user interface PCB 914 by any suitable method (e.g., board-to-board connector, cable).

Referring now to FIGS. 16-19, as described above, electronics enclosure 904 may include several features configured to retain and locate the first PCB 906 and the second PCB 908. The features include, but are not limited to, ribs 916 which support and maintain a required separation distance between PCBs 906 and 908, and PCB stopper protrusions 918 which prevent the PCBs 906 from extending too far out of the electronics enclosure 904. Lock features 920 may be configured to detachably couple a front portion 922 of the electronics enclosure 904 to the user interface component 902. Recesses 924 proximate to the front portion 922 may ensure error free installation of the PCBs 906 and 908 into the electronics enclosure 904. Gasket seal 926 may permit the refrigeration control unit to achieve an IP54 water ingress rating when mounted into a panel cutout.

Turning now to FIGS. 20 and 21, front elevation views of a refrigeration unit control devices 100 and 900 are shown, according to some embodiments. As described above, in various embodiments, user interface component 108 of refrigeration control unit device 100 and user interface component 902 of refrigeration control unit device 900 are identical or substantially similar. Each of the user interface components 108 and 902 is shown to include a display 2000. The displays 2000 may include a seven segment alphanumeric dot matrix display component 2002 combined with a standard 3-digit segmented LCD component 2004 for temperature display. The seven segment dot matrix display component 2002 may be configured to permit plain language information to scroll across the display in a variety of languages. In some embodiments, the dot matrix display component 2002 is configured to display alarm details, as opposed to numeric alarm codes. This feature allows all possible alarms to be displayed with specific details, which leads to easier and faster troubleshooting. In addition to the scrolling parameter portion, the displays 2000 may also be configured to display a setpoint temperature and/or a current temperature of the refrigeration unit. For example, as shown in FIGS. 20 and 21, the setpoint temperature of the unit may be 72° F., while the current temperature of the unit may be 73° F.

In addition to the displays 2000, user interface components 108 and 902 may include several touch screen controls 2006. The touch screen controls 2006 may include an overlay with eight capacitive sensor-based buttons organized in a first column 2008 and a second column 2010. The overlay may be pasted on the front surface of the user interface components 108 and 902 to meet IP54 water ingress standards. In some embodiments, the buttons in the first column 2008 include more frequently used buttons, while the second column 2010 includes less frequently used buttons. This layout enables alarm, defrost, and fan control on direct button press. In an alternative embodiment, the touch screen controls 2006 include six capacitive sensor-based buttons and two indicators.

In various embodiments, the touch screen controls 2006 may include, among other controls, a MENU/ESC control, a defrost button, a down arrow control, an up arrow control, and a SET control. The MENU/ESC control may be configured to allow a user to navigate through a menu structure. In some embodiments, both the MENU/ESC control button and the defrost button are configured to operate with a long press feature that requires a user to depress the button for a slightly longer than average time in order to avoid the accidental operation of these buttons. The spacing between the touch screen controls 2006 may also be configured to prevent accidental button operation. The touch screen controls 2006 are further shown to include an alarm button. The alarm button may include a multicolor lighting feature that indicates the criticality of the alarm. For example, the alarm button may be illuminated red for a more critical alarm, and yellow for a less critical alarm.

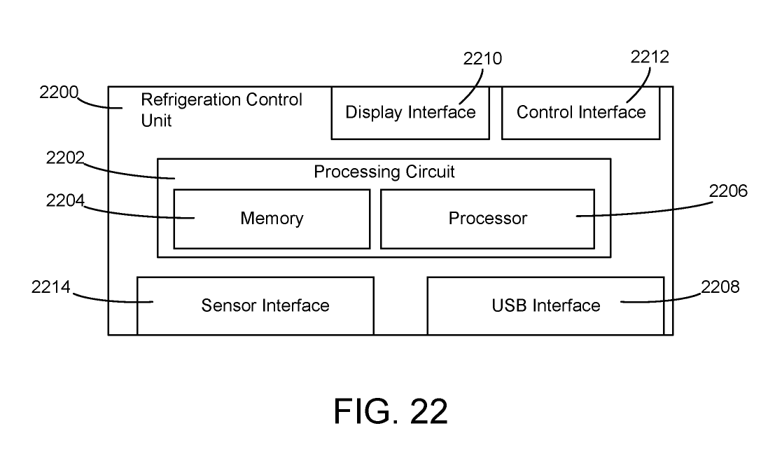

Referring now to FIG. 22, a block diagram of a refrigeration control unit 2200 is depicted, according to some embodiments. In various embodiments, refrigeration control unit 2200 is identical or substantially similar to the refrigeration control units described above. Refrigeration control unit 2200 is shown to include a processing circuit 2202. Processing circuit 2202 can be communicably connected to USB interface 2208, display interface 2210, control interface 2212, and sensor interface 2214 such that processing circuit 2202 and the various components thereof can send and receive data via interfaces 2208-2212.

Processing circuit 2202 may include memory 2204 and a processor 2206. Processor 2206 can be implemented as a general purpose processor, an application specific integrated circuit (ASIC), one or more field programmable gate arrays (FPGAs), a group of processing components, or other suitable electronic processing components. Memory 2204 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 2204 can be or include volatile memory or non-volatile memory. Memory 2204 may include database components, object code components, script components, or any other type of information structure for supporting the various activities and information structures described in the present application. According to some embodiments, memory 2204 is communicably connected to processor 2206 via processing circuit 2202 and includes computer code for executing (e.g., by processing circuit 2202 and/or processor 2206) one or more processes described herein. In various embodiments, the processing circuit may be communicably coupled to various components of the refrigeration equipment (not shown) and control signals transmitted to the refrigeration equipment from the processing circuit 2202 may modify an operating condition of the refrigeration equipment.

Refrigeration control unit 2200 is further shown to include a USB interface 2208, a display interface 2210, a control interface 2212, and a sensor interface 2214. USB interface 2208 may be communicably coupled to a USB port (e.g., USB port 104) accessible from the exterior of the refrigeration control unit 100. In some embodiments, USB interface 2208 may be used to update control unit firmware. For example, as updates to the system become available, a user may obtain the updated firmware and upload it to control unit 2200 via USB interface 2208. In still further embodiments, USB interface 2208 may be used in a configuration setting cloning process, described above with reference to FIG. 3.

Display unit interface 2210 may be communicably coupled to a display (e.g., display 2000), while control interface 2212 may be communicably coupled to unit controls (e.g., touch screen controls 2006). Based on data received from the unit controls via the control interface 2212, the processing circuit 2202 may execute processes and output data (e.g., selected refrigeration unit parameters) that are displayed on the unit display 2210.

Refrigeration control unit 2200 is further shown to include a sensor interface 2214. Sensor interface 2214 may be configured to receive input data from one or more sensors (e.g., temperature sensors). When multiple sensors are connected to sensor interface 2214, processing circuit 2202 may be configured to utilize a weighted average for process control (e.g., the processing circuit 2202 may transmit commands to modifying an operating condition of the refrigeration control unit 2200 based on the weighted average). For example, temperatures might vary across a freezer compartment (e.g., in an evaporator defrosting process, ice might melt at different rates), and a user may choose to weight a first temperature sensor at 25% of the temperature average and a second sensor at 75% of the temperature average. In some embodiments, the user selects a weight for each sensor using the touch screen controls of the refrigeration control unit. The equation for obtaining the weighted average may be as follows:

$$( 1 st sensor weight * 1 st sensor reading ) + ( 2 nd sensor weight * 2 nd sensor reading ) … + ( nth sensor weight * nth sensor reading ) = Weighted Average$$

Therefore, if the first temperature sensor reports a temperature of 100° F. and the second sensor reports a temperature of 90° F., the weighted average may be obtained as follows:

(0.25*100)+(0.75*90)=92.5

Numerous specific details are described to provide a thorough understanding of the disclosure. However, in certain instances, well-known or conventional details are not described in order to avoid obscuring the description. References to “some embodiments,” “one embodiment,” “an exemplary embodiment,” and/or “various embodiments” in the present disclosure can be, but not necessarily are, references to the same embodiment and such references mean at least one of the embodiments.

Alternative language and synonyms may be used for any one or more of the terms discussed herein. No special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

The elements and assemblies may be constructed from any of a wide variety of materials that provide sufficient strength or durability, in any of a wide variety of colors, textures, and combinations. Further, elements shown as integrally formed may be constructed of multiple parts or elements.

As used herein, the word “exemplary” is used to mean serving as an example, instance or illustration. Any implementation or design described herein as “exemplary” is not necessarily to be construed as preferred or advantageous over other implementations or designs. Rather, use of the word exemplary is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary implementations without departing from the scope of the appended claims.

As used herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As used herein, the term “coupled” means the joining of two members directly or indirectly to one another. Such joining may be stationary in nature or moveable in nature and/or such joining may allow for the flow of fluids, electricity, electrical signals, or other types of signals or communication between the two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A refrigeration control unit configured to modify an operating condition of a refrigeration unit, comprising:
a first device housing component;
a second device housing component, the first device housing component and the second device housing component defining a main refrigeration control device; and
a user interface component, comprising:
a plurality of controls configured to permit selection of a plurality of refrigeration unit operating parameters; and
a display;
wherein the user interface component is configured to be detachably coupled to the main refrigeration control device such that the user interface component is operational both when mounted in the main refrigeration control device and when mounted at a location remote to the main refrigeration control device.

2. The refrigeration control unit of claim 1, wherein the user interface component is electrically coupled to the main refrigeration control device using an accessory cable.

3. The refrigeration control unit of claim 2, wherein the accessory cable has a length ranging from 8 feet to 12 feet.

4. The refrigeration control unit of claim 1, wherein the user interface component has an IP54 ingress protection rating.

5. The refrigeration control unit of claim 1, wherein the plurality of controls comprise capacitive sensor-based buttons.

6. The refrigeration control unit of claim 1, wherein the main refrigeration control device further comprises a low voltage component circuit board and a high voltage component circuit board.

7. The refrigeration control unit of claim 1, wherein the second device housing component comprises a plurality of features configured to permit the refrigeration control unit to mount to a DIN rail.

8. The refrigeration control unit of claim 1, wherein the first device housing component and the second device housing component are coupled using a snap fit assembly process.

9. The refrigeration control unit of claim 1, wherein the refrigeration unit is at least one of a walk-in refrigerator, a cooler, and a freezer case.

10. A refrigeration control unit configured to modify an operating condition of a refrigeration unit, comprising:
a first device housing component;
a second device housing component;
a plurality of controls configured to permit selection of a plurality of parameter values for a plurality of refrigeration unit operating parameters; and
a processing circuit communicably coupled to the plurality of controls and a plurality of sensors, the processing circuit configured to:
receive a plurality of sensor measurements from the plurality of sensors;
receive a command from the plurality of controls to assign a sensor weight to each of the plurality of sensor measurements;
calculate a weighted average from the plurality of sensor measurements; and
transmit a command to modify an operating condition of the refrigeration unit based at least in part on the weighted average.

11. The refrigeration control unit of claim 10, wherein the plurality of sensors comprise temperature sensors.

12. The refrigeration control unit of claim 10, wherein the plurality of controls comprise capacitive sensor-based buttons.

13. The refrigeration control unit of claim 10, wherein the plurality of refrigeration unit operating parameters comprises at least one of a temperature unit, a backlight intensity, a system name, a time format, a date format, and an alarm setting.

14. The refrigeration control unit of claim 10, wherein the plurality of refrigeration unit operating parameters comprise defrost parameters including at least one of a defrost type, a defrost termination type, a defrost duration, a number of defrosts performed per 24 hour period, and a defrost schedule.

15. The refrigeration control unit of claim 10, wherein the plurality of refrigeration unit operating parameters comprise sensor parameters including at least one of a sensor type, a sensor offset, a sensor measurement function, and a sensor weight.

16. The refrigeration control unit of claim 10, wherein the processing circuit is further configured to:
receive a command from the plurality of controls to create a configuration file, the configuration file comprising the plurality of refrigeration unit operating parameters and the plurality of parameter values; and
export the configuration file to a removable storage device, the removable storage device communicably coupled to a universal serial bus (USB) port of the refrigeration control unit.

17. The refrigeration control unit of claim 10, wherein the refrigeration control unit is configured to control at least one of a walk-in refrigerator, a cooler, and a freezer case.

18. A method for operating a refrigeration unit using a refrigeration control unit, comprising:
receiving a plurality of sensor measurements from a plurality of sensors;
receiving a command from a plurality of controls to assign a sensor weight to each of the plurality of sensor measurements;
calculating a weighted average from the plurality of sensor measurements;
transmitting a command to modify an operating condition of the refrigeration unit based at least in part on the weighted average.

19. The method of claim 18, wherein the plurality of sensor measurements are temperature measurements.

20. The method of claim 18, further comprising:
receiving a command from the plurality of controls to create a configuration file, the configuration file comprising a plurality of refrigeration unit operating parameters and a plurality of parameter values; and
exporting the configuration file to a removable storage device, the removable storage device communicably coupled to a universal serial bus (USB) port of the refrigeration control unit.
